(19) United States
(12) Patent Application Publication
(10) Pub. No.: US 2026/0118597 A1
(43) Pub. Date: Apr. 30, 2026

(54) FIBER OPTICAL CONNECTORS

(71) Applicant: PPC BROADBAND, INC., East Syracuse, NY (US)

(72) Inventors: William CRAWFORD, Syracuse, NY (US); Noah MONTENA, Syracuse, NY (US)

(73) Assignee: PPC BROADBAND, INC., East Syracuse, NY (US)

(21) Appl. No.: 19/431,682

(22) Filed: Dec. 23, 2025

Related U.S. Application Data
(63) Continuation of application No. 16/740,391, filed on Jan. 10, 2020, now Pat. No. 12,504,586.
Application No. 16/740,391 is a continuation-in-part of application No. 16/532,476, filed on Aug. 5, 2019, now abandoned.
(60) Provisional application No. 62/790,503, filed on Jan. 10, 2019.
(60) Provisional application No. 62/714,123, filed on Aug. 3, 2018.

(51) Int. Cl. G02B 6/38

(52) U.S. Cl. CPC G02B 6/3869; G02B 6/387; G02B 6/38875; G02B 6/3888

(57) ABSTRACT

A fiber optic connector for terminating a fiber optic cable may include an inner housing, an outer housing, a connector sub-assembly, and a crimp sleeve. The outer housing may be disposed radially outward of the inner housing, and the connector sub-assembly includes a ferrule basket configured to receive a ferrule that terminates a fiber of the fiber optic cable. The crimp sleeve may surround and be crimped onto a rearward portion of the connector sub-assembly and an end portion of the fiber optic cable. The inner housing may be configured to be securely disposed about the crimp sleeve, and the outer housing may be configured to be secured disposed about the inner housing.

### CROSS-REFERENCE TO RELATED APPLICATIONS

This is a Continuation of U.S. Patent Application No. 16/740,391, filed January 10, 2020, pending, which is a Continuation-in-Part of Application No. 16/532,476, filed August 5, 2019, pending, which claims the benefit of U.S. Provisional Application No. 62/714,123, filed August 3, 2018. U.S. Patent Application No. 16/740,391 also claims the benefit of U.S. Provisional Application No. 62/790,503, filed January 10, 2019. The disclosures of the prior applications are hereby incorporated by reference herein in their entirety.

### TECHNICAL FIELD

The present disclosure is directed to a fiber optical connector that attaches a connector sub-assembly to an optical fiber cable without the use of an outer clamp shell. More particularly, a fiber optical connector includes a one-piece inner housing that connects the connector sub-assembly to the optical fiber cable.

The present disclosure is directed to a fiber optical connector with a retention feature and, more particularly, to a hardened fiber optical connector that allows for easy field assembly. The hardened fiber optical connector has an inner housing that directly attaches a preterminated optical fiber cable to a ferrule without the use of an outer clamp shell.

### BACKGROUND

Fiber optical communication systems typically use a network of fiber optic cables to transmit large volumes of data. Typical fiber optical connectors include a ferrule that supports an end portion of an optical fiber. When two fiber optical connectors are interconnected, end faces of the ferrules, on each connector, directly oppose one another. Thus, the optical fibers, which are supported by each ferrule, are also directly opposed to each other. Furthermore, springs in each connector bias the optical fibers towards each other when the connectors are in this interconnected state. An optical signal can then be transmitted from one optical fiber to the other optical fiber.

Traditionally, the ferrule may be disposed in a ferrule holder carrier, which is then secured to an outer barrel. Conventional outer barrels include a clamp shell arrangement in order to easily fit the barrel around and over the ferrule holder carrier and the cable. Thus, the clamp shell may open in order to move the barrel over and around these components. An outer housing may then be disposed over the clamp shell in order to provide a secure and stable connector assembly.

It may be desirable to provide a hardened optical fiber connector that overcomes one or more problems of conventional prior art connectors that are recognized by persons having ordinary skill in the art.

### SUMMARY

According to various aspects of the present disclosure, a fiber optic connector for terminating a fiber optic cable includes an inner housing, an outer housing, a connector sub-assembly, and a crimp sleeve. The outer housing is disposed radially outward of the inner housing, and the connector sub-assembly includes a ferrule basket configured to receive a ferrule that terminates a fiber of the fiber optic cable. The crimp sleeve surrounds and is crimped onto a rearward portion of the connector sub-assembly and an end portion of the fiber optic cable. The inner housing is configured to be securely disposed about the crimp sleeve, and the outer housing is configured to be secured disposed about the inner housing.

The present disclosure is directed to a fiber optical connector that can be easily assembled in the field. The fiber optical connector includes a barrel, one or more latches, and a ferrule housing sub-assembly. The barrel includes an inner lumen that is configured to receive an optical fiber cable, and the barrel has a first end and a second end. The one or more latches extend from the first end of the barrel. Additionally, the ferrule housing sub-assembly includes a ferrule holder carrier that is configured to receive a ferrule. The latches engage with the ferrule holder carrier in order to secure the barrel with the ferrule housing sub-assembly.

### BRIEF DESCRIPTION OF THE DRAWINGS

Features and advantages of the present disclosure are described in, and will be apparent from, the following Brief Description of the Drawings and Detailed Description.

FIG. 1 is a perspective view of an exemplary hardened fiber optic connector in accordance with various aspects of the disclosure.

FIG. 2 is a top cross-sectional view of the exemplary connector of FIG. 1.

FIG. 3 is a perspective view of the inner housing of the exemplary connector of FIG. 1.

FIG. 4 is a side cross-sectional view of the inner housing of FIG. 3.

FIG. 5 is a top view of the inner housing of FIG. 3.

FIG. 6 is an exploded perspective view of the exemplary connector of FIG. 1.

FIG. 7 is a side view of the connector sub-assembly and crimp sleeve of the exemplary connector of FIG. 1.

FIG. 8 is an enlarged cross-sectional view of the connector sub-assembly of the exemplary connector of FIG. 1.

FIG. 9 is a perspective view of another exemplary hardened fiber optic connector in accordance with various aspects of the disclosure.

FIG. 10 is a side view of the exemplary connector of FIG. 9.

FIG. 11 is a perspective view of another exemplary hardened fiber optic connector in accordance with various aspects of the disclosure.

FIG. 12 is a side cross-sectional view of the exemplary connector of FIG. 11.

FIG. 13 is an exploded perspective view of the inner housing of the exemplary connector of FIG. 11.

FIG. 14 is a perspective view of the inner housing and the connector sub-assembly of the exemplary connector of FIG. 11.

FIG. 15 is a side cross-sectional view of the inner housing and the connector sub-assembly of FIG. 14.

FIG. 16 is an exploded perspective view of an exemplary connector in accordance with various aspects of the disclosure;

FIG. 17 is a perspective view of the inner housing and preconnectorized cable of the exemplary connector of FIG. 16;

FIG. 18 is a side cross-sectional view of the inner housing and preconnectorized cable of the exemplary connector of FIG. 16;

FIG. 19 is a perspective view of the inner housing and boot of the exemplary connector of FIG. 16;

FIG. 20 is a perspective view of the inner housing of the exemplary connector of FIG. 16;

FIG. 21 is a side cross-sectional view of the exemplary connector of FIG. 16;

FIG. 22 is a side cross-sectional view of another exemplary connector in accordance with various aspects of the disclosure;

FIG. 23 is a partially-exploded perspective view of another exemplary connector in accordance with various aspects of the disclosure;

FIG. 24 is a side cross-sectional view of the exemplary connector of FIG. 23;

FIG. 25 is a perspective view of the inner housing of the exemplary connector of FIG. 23.

### DETAILED DESCRIPTION OF EMBODIMENTS

Throughout the description, like reference numerals will refer to like parts in the various drawing figures. As a preface to the detailed description, it should be noted that, as used in this specification and the appended claims, the singular forms "a," "an," and "the" include plural referents, unless the context clearly dictates otherwise.

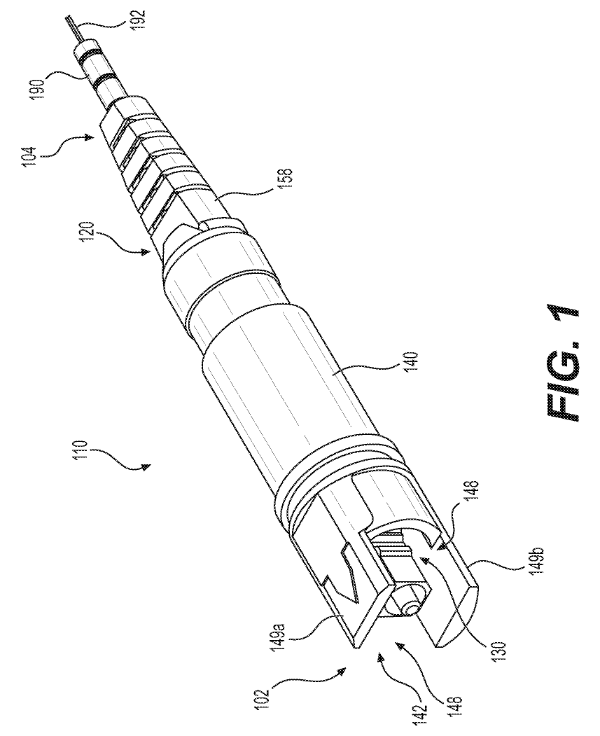

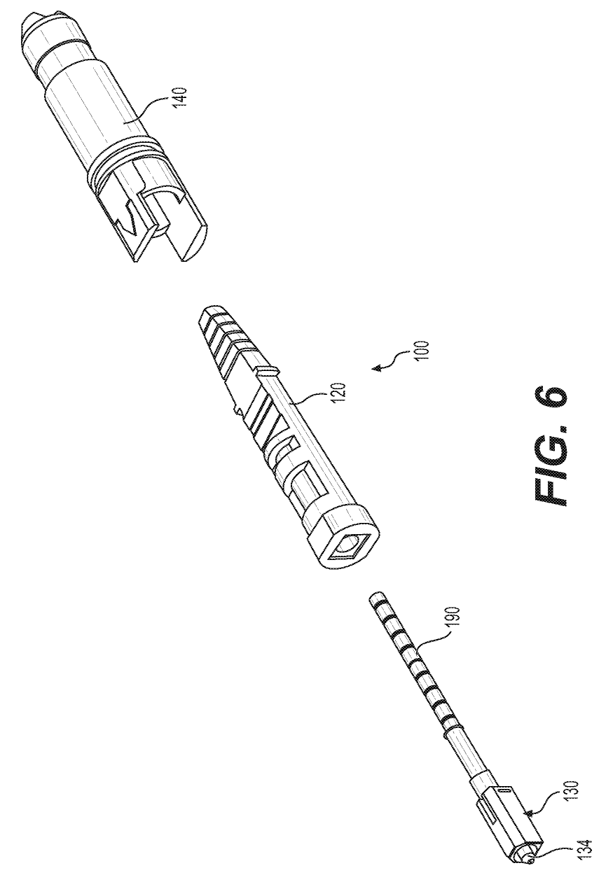

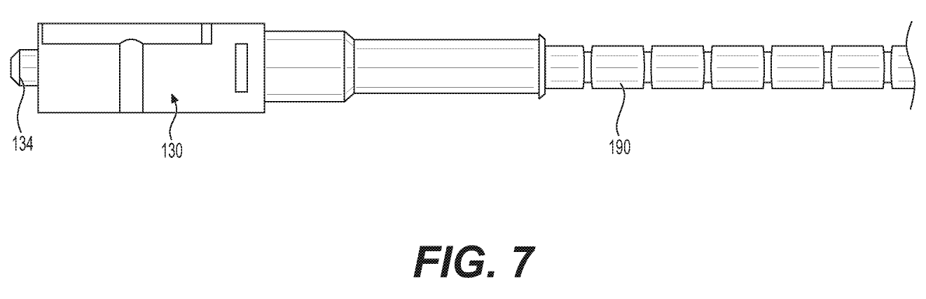

FIGS. 1-8 illustrate an exemplary fiber optical connector 100, for example, a hardened fiber optic connector, for terminating an optical fiber cable 190. The optical fiber cable 190 may include one or more fibers; however, the connector 100 is configured to terminate a single fiber 192. The fiber optical connector 100 includes a forward end 102 configured to be coupled with a fiber optic receptacle and a rearward end 104 into which the optical fiber cable 190 extends. The fiber optical connector 100 extends in a longitudinal axial direction from the forward end 102 to the rearward end 104. It should be appreciated that the mating between the fiber optical connector 100 and the receptacle may be secured using a threaded engagement, a quarter-turn lock, a quick release, a push-pull latch, or a bayonet configuration.

The connector 100 includes an inner housing 120, a connector sub-assembly 130, an outer housing 140, and a crimp sleeve 180. The outer housing 140 surrounds at least a portion of the inner housing 120 and the connector sub-assembly 130, and the inner housing 120 is a single piece of unitary construction (i.e., a monolithic structure). Outer housing 140 may include a rigid material that is sufficient to withstand environmental conditions.

The fiber optical connector 100 uses a connector subassembly 130 of the SC type, but other types of connector assemblies such as LC, FC, ST, MT, and MT-RJ are contemplated by the present invention by using a suitable crimp housing. As illustrated, the connector sub-assembly 130 may be an industry standard SC type connector assembly having a connector body 132, a ferrule 134 in a ferrule basket 135, a spring 136, and a mandrel 138. As would be understood by persons skilled in the art, the ferrule 134 is held by the ferrule basket 135, which is axially slidable relative to the connector body 132 against a force of the spring 136 as limited by the connector body 132 and the mandrel 138.

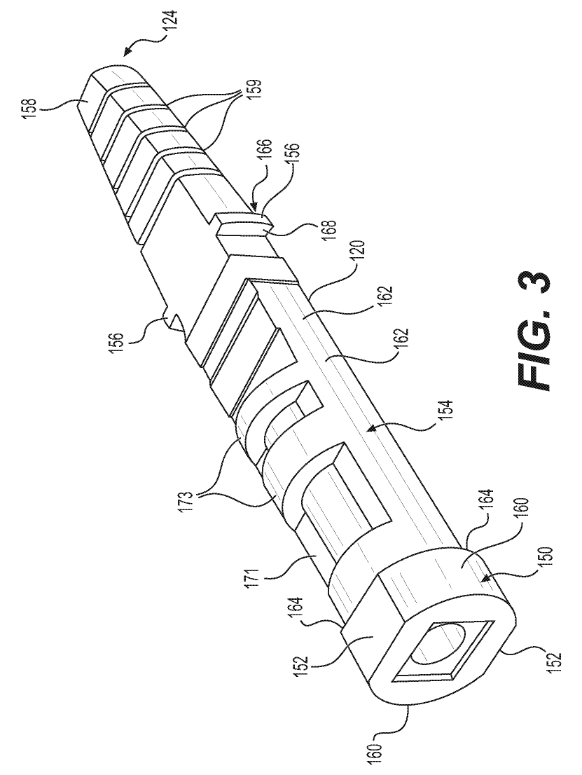

As shown in FIG. 3, the inner housing 120 includes a first end 122 toward the forward end 102 of the connector 100 and a second end 124 toward the rearward end 104 of the connector 100. The inner housing 120 includes a forward flange portion 150 having flattened outer peripheral portions 152 at opposed top and bottom regions of the forward flange portion 150. The flattened peripheral portions 152 of the forward flange portion 150 are configured to engage complementary portions of the outer housing 140 to prevent rotation of the inner housing 120 relative to the outer housing 140.

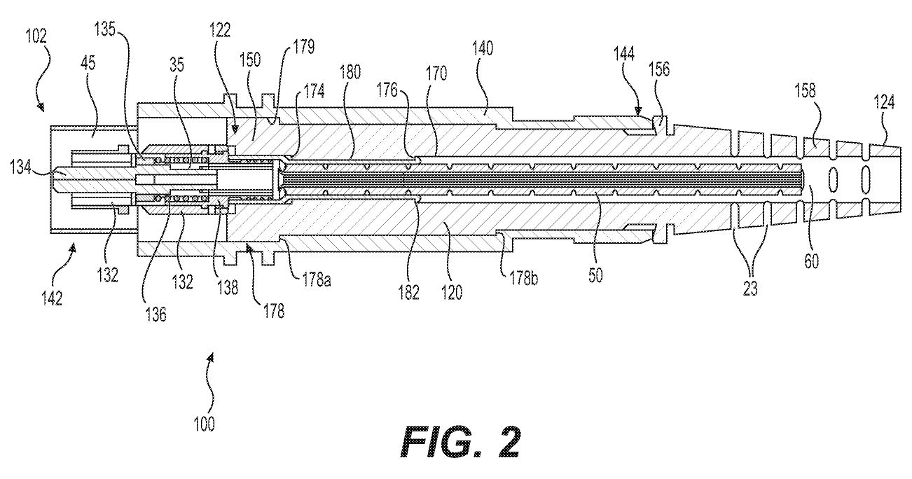

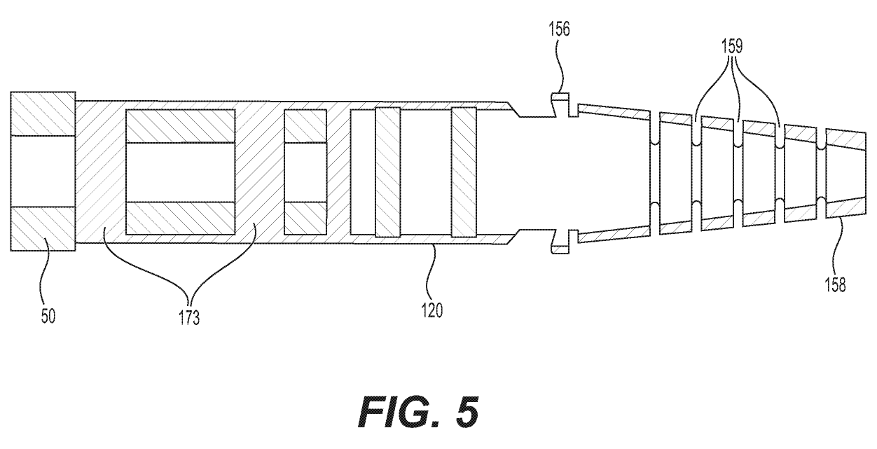

Referring to FIGS. 2 and 5, the inner housing 120 includes a body portion 154 extending from the forward flange portion 150 to a rearward flange portion 156 in the longitudinal direction and a boot portion 158 that extends rearward from the rearward flange portion 156 in the longitudinal direction. The boot portion 158 may be made from any conventional bendable material to provide strain relief for the cable 190. The boot portion 158 may include one or more notched portions 159 to enhance bendability of the boot portion 158. The boot portion 158 of the inner housing 120 may be a flexible member that provides an interface between the connector 100 and the optical fiber cable 190 and permits the optical fiber cable 190 to bend and/or and rotate relative to the connector 100.

The forward flange portion 156 includes a pair of opposed outer side walls 160 between the flattened peripheral portions 152 at the top and bottom regions. The body portion 154 has opposed outer side walls 162 aligned with the side walls 160 in the longitudinal direction. A side wall 162 to side wall 162 dimension in a transverse direction perpendicular to the longitudinal direction is less than a side wall 160 to side wall 160 dimension in the transverse direction. Thus, the inner housing 120 defines radially-extending surfaces 164 at the interface between the side walls 160 and the side walls 162 that face rearward in the longitudinal direction. Similarly, the rearward flange portion 156 includes a pair of opposed side walls 166 aligned with the side walls 160 and the side walls 162 in the longitudinal direction. A side wall 162 to side wall 162 dimension in a transverse direction perpendicular to the longitudinal direction is less than a side wall 166 to side wall 166 dimension in the transverse direction. Thus, the inner housing 120 defines radially-extending surfaces 168 at the interface between the side walls 166 and the side walls 162 that face forward in the longitudinal direction. As discussed in more detail below, the rearward facing surfaces 164 and the forward facing surfaces 168 are configured to secure the outer housing 140 to the inner housing 120.

As shown in FIG. 2, the inner housing 120 has an inner wall 170 that extends in the longitudinal direction and a projection 172 extending inward from the inner wall 170. The projection 172 may be an annular projection or one or more axial projections that are spaced apart from one another about the periphery of the inner wall 170. The projection 172 thus defines a radially-extending surface 174 that faces forward in the longitudinal direction and a radially-extending surface 176 that faces rearward in the longitudinal direction.

The outer housing 140 has a generally cylindrical shape with a first end 142 and a second end 144. The outer housing 140 generally protects the connector sub-assembly 130 and in some embodiments may also key the fiber optical connector 100 with the respective mating receptacle. Moreover, the outer housing 140 includes a through passageway between the first end 142 and the second end 144. As mentioned above, the passageway of the outer housing 140 is keyed so that inner housing 120 is inhibited from rotating when the fiber optical connector 100 is assembled. For example, an inner surface 178 of the outer housing includes flattened regions 179 that are configured to receive the complementary flattened peripheral portions 152 of the forward flange portion 150 to prevent rotation of the inner housing 120 relative to the outer housing 140. Additionally, the inner surface 178 of the outer housing 140 forming the passageway has one or more internal shoulders 178a, 178b configured to inhibit the inner housing 120 from being inserted into the outer housing 140 beyond a predetermined position.

The outer housing 140 includes at least one opening 148 extending from a medial portion of the outer housing 140 to the first end 142. In this case, the outer housing 140 includes a pair of opposed openings 148 at the first end 142, thereby defining alignment portions or fingers 149a, 149b. In addition to aligning the outer housing 140 with the receptacle during mating, alignment fingers 149a, 149b may protect the connector sub-assembly 130.

As shown in FIG. 1, the alignment fingers 149a, 149b may have different shapes and/or sizes so that the connector 100 can only mate with the receptacle in one orientation. It should be appreciated that the alignment fingers 149a, 149b may include alignment indicia so that a technician can quickly and easily mate the connector 100 with the receptacle. After the alignment fingers 149a, 149b are seated into the receptacle, the technician can engage the external threads of a coupling nut (not shown) with complementary internal threads of the receptacle to provide a secure optical connection.

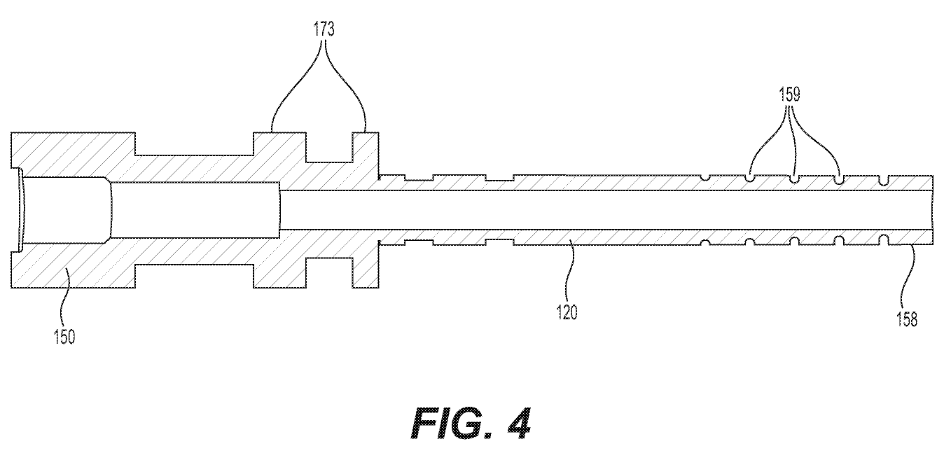

As best illustrated in FIGS. 3 and 4, the inner housing 120 has a generally flat outer wall 171 at top and bottom regions between the side walls 162. The inner housing 120 further includes one or more projections 173 extending outward from the outer wall 171. The one or more projections 173 are configured to substantially match the inner surface 178 of the outer housing 140 to seal the passageway. The portions of the flat outer wall 171 without the one or more projections facilitate sealing by the one or more projections 173 and reduce the overall material thickness to assist with the molding process, as would be understood by persons skilled in the art.

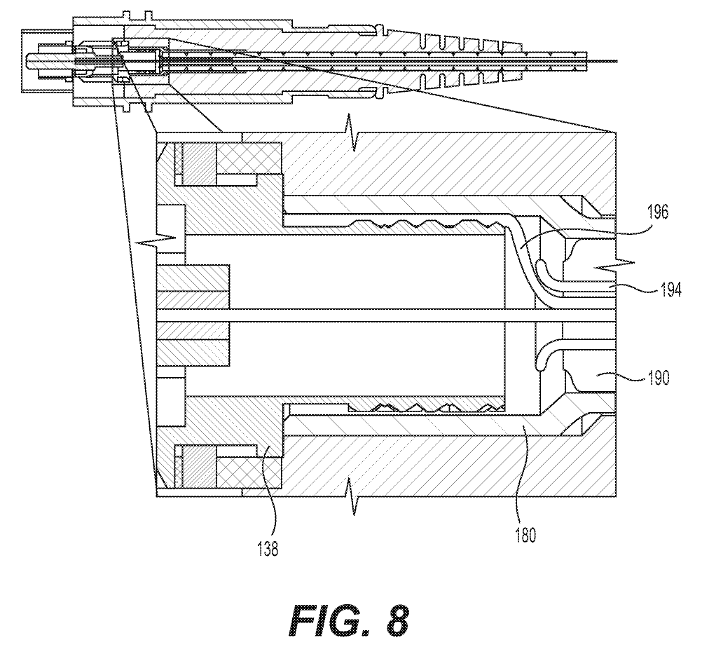

Referring to FIGS. 2 and 8, the connector 100 includes a crimp ferrule 194 configured to be inserted into the fiber optic cable 190 between the one or more fibers 192 and an outer jacket 196 of the cable 190. The crimp ferrule 194 protects the one or more fibers 192 during termination of the cable 190 with the connector 100. The fiber optic cable 190 may includes one or more strengthening members 198, for example, Kevlar strands that run through the length of the fiber optic cable 190 along side the one or more fibers 192.

As shown in FIG. 8, the crimp sleeve 180 extends over a rear portion of the mandrel 138 to a shoulder portion 139 of the mandrel 138 and over a forward portion of the fiber optic cable 190. The crimp sleeve 180 includes an annular barb 182 or one or more circumferential barb portions at its rearward end that are configured to secure the inner housing 120 relative to the crimp sleeve 180. In particular, the projection 172 that extends inward from the inner wall 170 is retained between a tapered region 184 of the crimp sleeve 180, which results from crimping onto the mandrel 138, and the annular barb 182.

With one of the strengthening members 198 disposed on a radially outer surface of the mandrel 138, the crimp sleeve 180 is crimped onto the mandrel 138 and the fiber optic cable 190 to secure the connector sub-assembly 130 to the fiber optic cable 190.

When terminating the fiber optic cable 190 with the connector 100, which typically occurs at a manufacturing facility, the coupling nut and the outer housing 140 are slid over the fiber optic cable 190, followed by the inner housing 120 and then the mandrel 138. The crimp ferrule 194 is then inserted into the end of the fiber optic cable 190. A fiber 192 of the cable 190 is terminated with the ferrule 134, and the connector sub-assembly 130 is placed adjacent the fiber optic cable 190. A strengthening member 198 may be placed onto an outer surface of the rear portion of the mandrel 138. The crimp sleeve 180 is then moved forward over the rearward portion of the mandrel 138 until reaching the shoulder 139, while the rear portion of the mandrel 138 surrounds the fiber optic cable 190. The crimp sleeve 190 is crimped onto the mandrel 138 and the fiber optic cable 190 to secure the cable 190 to the connector sub-assembly 130.

Next, the inner housing 120 is slid forward until the projection 172 that extends inward from the inner wall 170 is retained between the tapered region 184 of the crimp sleeve 180 and the annular barb 182 at the rearward end of the crimp sleeve 180. The elastic nature of the inner housing 120, which is made, for example, from rubber or any known elastomer, enables the inner housing 120 to defect over the annular barb 182 and onto the outer surface of the inner housing 120. The outer housing 140 is the slide forward over the inner housing 120 until a shoulder 141 of the outer housing 140 reaches the rearward facing surfaces 164 of the inner housing 120 and the rear end 144 of the outer housing 140 is positioned forward of the forward facing surfaces 168 of the rearward flange portion 156. The coupling nut can then be slid forward to a position limited by projections from the outer surface of the outer housing so as to be configured to couple the connector 100 to the receptacle.

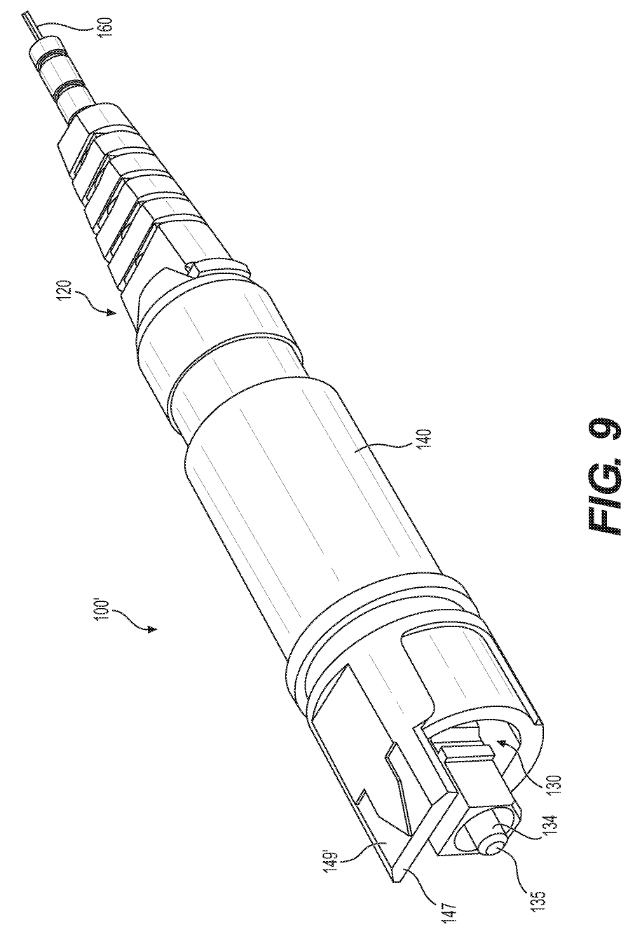

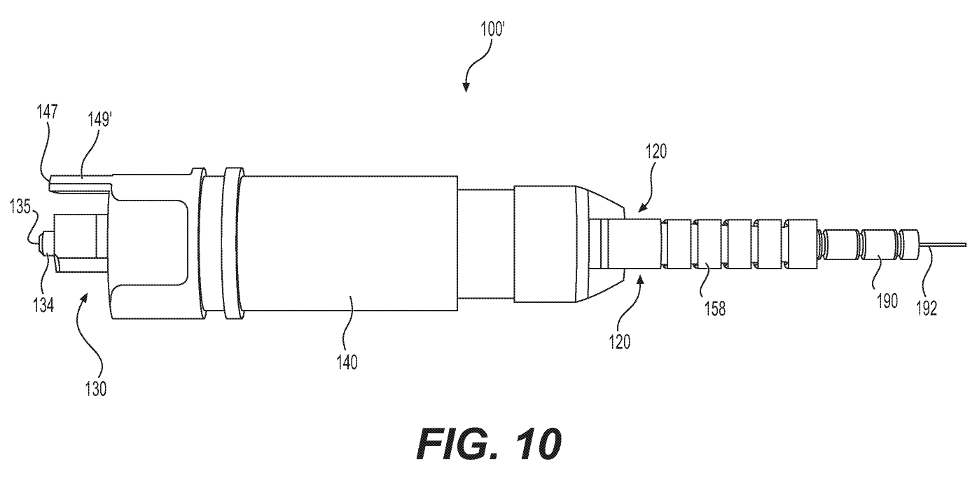

FIGS. 9 and 10 illustrate another exemplary fiber optical connector 100', for example, a hardened fiber optic connector, for attachment of an optical fiber cable with a ferrule. Connector 100' includes the inner housing 120, the connector sub-assembly 130, and the crimp sleeve 180 as described above in connection with the embodiment of FIGS. 1-8. The outer housing 140' is similar to the outer housing 140 described above, but the first end 142' of the outer housing 140' includes only a single projection 149' disposed radially outward of ferrule housing sub-assembly 130. Also, as shown in FIG. 10, the single projection 149' has a length configured such that a forward end 147 of the projection 149' does not extend beyond a forward end 135 of the ferrule 134 of the ferrule housing sub-assembly 130.

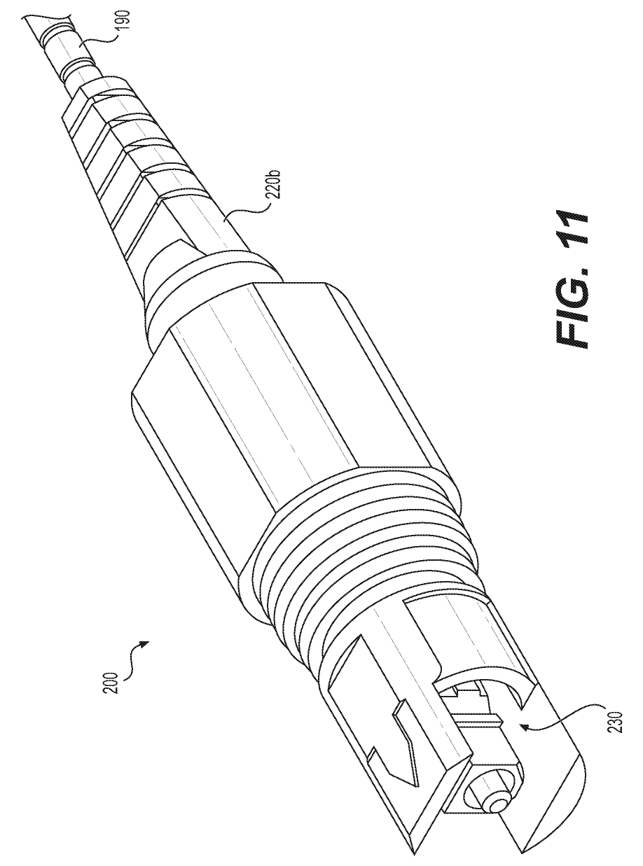

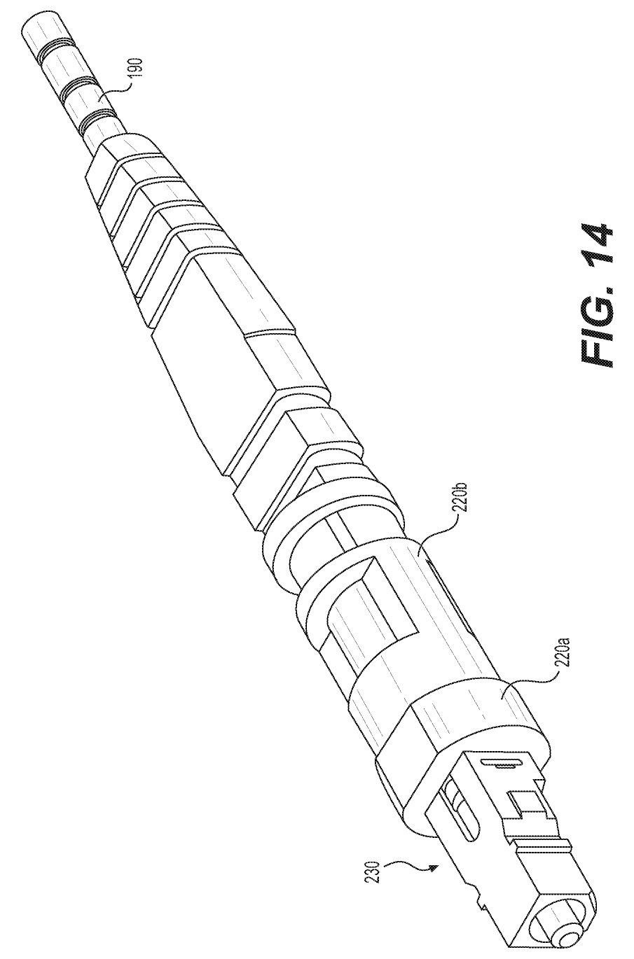

FIGS. 11-15 illustrate another exemplary fiber optical connector 200, for example, a hardened fiber optic connector, for attachment of an optical fiber cable with a ferrule. The connector 200 includes a connector sub-assembly 230, an outer housing 240, and a crimp sleeve 280, which are similar to the same parts described above in connection with the embodiment of FIGS. 1-8. The connector 200 further includes a first inner housing 220a and a second inner housing 220b. The outer housing 240 surrounds the first inner housing 220a and at least a portion of the second inner housing 220a and the connector sub-assembly 230. The first inner housing 220a is constructed of a relatively rigid plastic that is more rigid that the second inner housing 220b, which is constructed of rubber or an elastomer. Outer housing 240 may include a rigid material that is sufficient to withstand environmental conditions.

The fiber optical connector 200 uses a connector subassembly 230 of the SC type, but other types of connector assemblies such as LC, FC, ST, MT, and MT-RJ are contemplated by the present invention by using a suitable crimp housing. As illustrated, the connector sub-assembly 230 may be an industry standard SC type connector assembly having a connector body 232, a ferrule 234 in a ferrule basket 235, a spring 236, and a mandrel 238. As would be understood by persons skilled in the art, the ferrule 234 is held by the ferrule basket 235, which is axially slidable relative to the connector body 232 against a force of the spring 236 as limited by the connector body 232 and the mandrel 238.

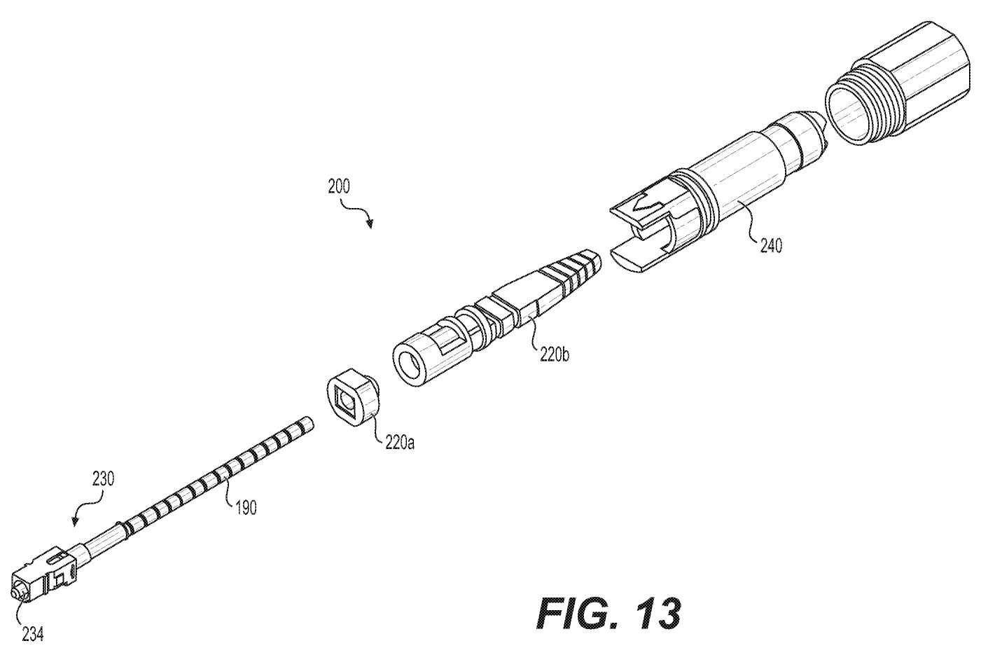

As shown in FIG. 13, the first inner housing 220a is disposed toward the forward end 202 of the connector 200 relative to the second inner housing 220b. The first inner housing 220a has a first forward end 222 configured to engage a shoulder 278 defined by an inner surface 278 of the outer housing 240 to limit the distance that the first inner housing 220a can move in the forward direction relative to the outer housing 240. A second rearward end 224 of the first inner housing 220a includes a radially outward extending barb 225 toward the rearward end 204 of the connector 200. The first forward end 222 of the first inner housing 220a includes flattened outer peripheral portions 252 at opposed top and bottom regions of the first inner housing 220a. The flattened peripheral portions 252 are configured to engage complementary portions of the outer housing 240 to prevent rotation of the first inner housing 220a relative to the outer housing 240.

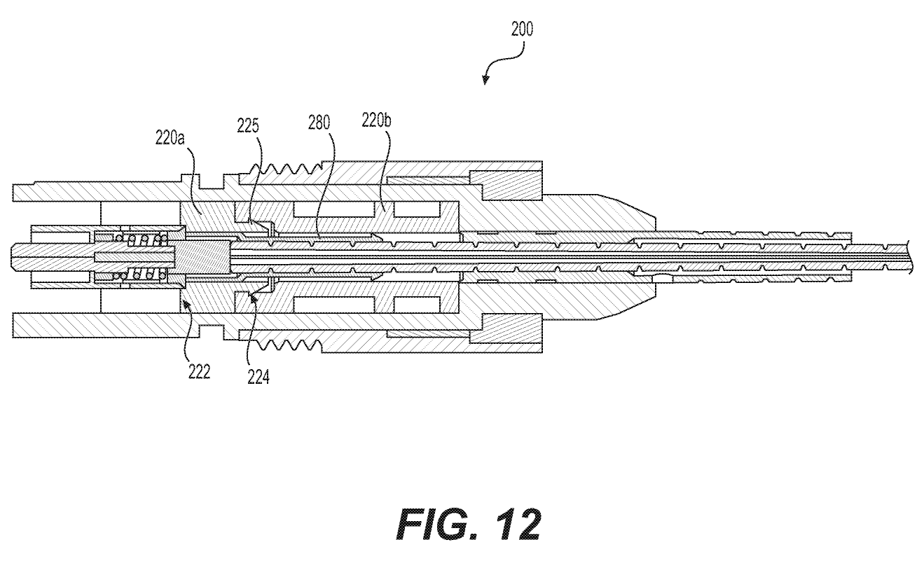

Referring to FIGS. 12 and 13, the second inner housing 220b includes a body portion 254 extending from the first inner housing 220a to a rearward boot portion 258 that extends rearward in the longitudinal direction. The boot portion 258 may be made from any conventional bendable material to provide strain relief for the cable 190. The boot portion 258 may include one or more notched portions 259 to enhance bendability of the boot portion 258. The boot portion 258 of the second inner housing 220b may be a flexible member that provides an interface between the connector 200 and the optical fiber cable 190 and permits the optical fiber cable 190 to bend and/or and rotate relative to the connector 200.

As shown in FIG. 12, the second inner housing 220b has an inner wall 270 that extends in the longitudinal direction and a projection 272 extending inward from the inner wall 270. The projection 272 may be an annular projection or one or more axial projections that are spaced apart from one another about the periphery of the inner wall 270. The projection 272 thus defines a radially-extending surface 274 that faces forward in the longitudinal direction and a radially-extending surface 276 that faces rearward in the longitudinal direction.

The outer housing 240 has a generally cylindrical shape with a first end 242 and a second end 244. The outer housing 240 generally protects the connector sub-assembly 230 and in some embodiments may also key the fiber optical connector 200 with the respective mating receptacle. Moreover, the outer housing 240 includes a through passageway between the first end 242 and the second end 244. As mentioned above, the passageway of the outer housing 240 is keyed so that the first inner housing 220a is inhibited from rotating when the fiber optical connector 200 is assembled. For example, an inner surface 278 of the outer housing includes flattened regions 279 that are configured to receive the complementary flattened peripheral portions 252 of the forward flange portion 250 to prevent rotation of the first inner housing 220a relative to the outer housing 240. Additionally, the inner surface 278 of the outer housing 240 forming the passageway has the shoulder 278 configured to inhibit the first inner housing 220a from being inserted into the outer housing 240 beyond a predetermined position.

The outer housing 240 includes at least one opening 248 extending from a medial portion of the outer housing 240 to the first end 242. In this case, the outer housing 240 includes a pair of opposed openings 248 at the first end 242, thereby defining alignment portions or fingers 249a, 249b. In addition to aligning the outer housing 240 with the receptacle during mating, alignment fingers 249a, 249b may protect the connector sub-assembly 230.

As shown in FIG. 11, the alignment fingers 249a, 249b may have different shapes and/or sizes so that the connector 200 can only mate with the receptacle in one orientation. It should be appreciated that the alignment fingers 249a, 249b may include alignment indicia so that a technician can quickly and easily mate the connector 200 with the receptacle. After the alignment fingers 249a, 249b are seated into the receptacle, the technician can engage the external threads of a coupling nut (not shown) with complementary internal threads of the receptacle to provide a secure optical connection.

As best illustrated in FIG. 13, the second inner housing 220b has a generally flat outer wall 271 at top and bottom regions between the side walls 262. The second inner housing 220b further includes one or more projections 273 extending outward from the outer wall 271. The one or more projections 273 are configured to substantially match the inner surface 278 of the outer housing 240 to seal the passageway. The portions of the flat outer wall 271 without the one or more projections facilitate sealing by the one or more projections 273 and reduce the overall material thickness to assist with the molding process, as would be understood by persons skilled in the art.

Referring to FIG. 2, the connector 200 includes a crimp ferrule 294 configured to be inserted into the fiber optic cable 190 between the one or more fibers 192 and an outer jacket 196 of the cable 190. The crimp ferrule 294 protects the one or more fibers 192 during termination of the cable 190 with the connector 200. The fiber optic cable 190 may includes one or more strengthening members 198, for example, Kevlar strands that run through the length of the fiber optic cable 190 along side the one or more fibers 192.

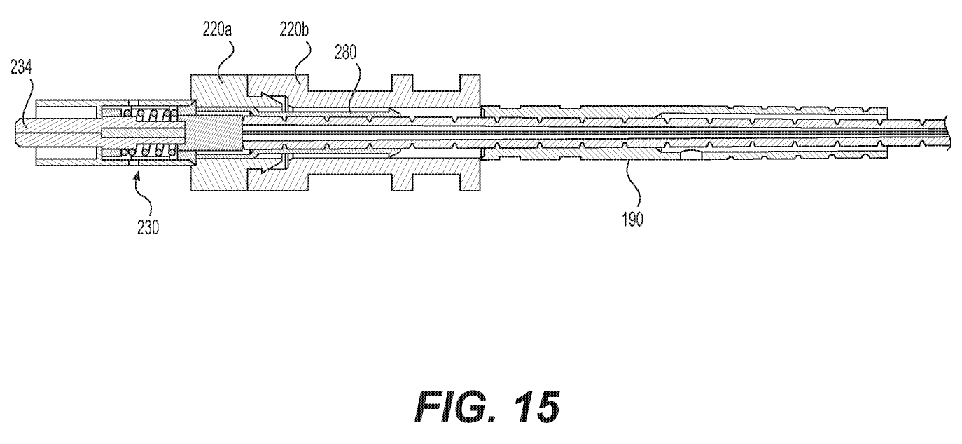

As shown in FIGS. 12 and 15, the crimp sleeve 280 extends over a rear portion of the mandrel 238 to a shoulder portion 239 of the mandrel 238 and over a forward portion of the fiber optic cable 190. The crimp sleeve 280 includes an annular barb 282 or one or more circumferential barb portions at its rearward end that are configured to secure the second inner housing 220b relative to the crimp sleeve 280. With one of the strengthening members 198 disposed on a radially outer surface of the mandrel 238, the crimp sleeve 280 is crimped onto the mandrel 238 and the fiber optic cable 190 to secure the connector sub-assembly 230 to the fiber optic cable 190.

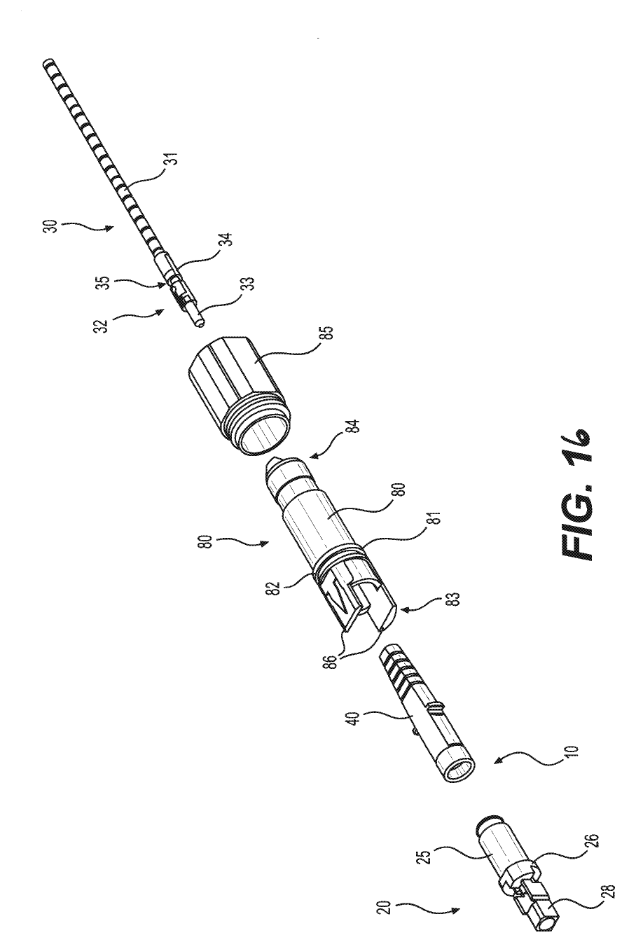

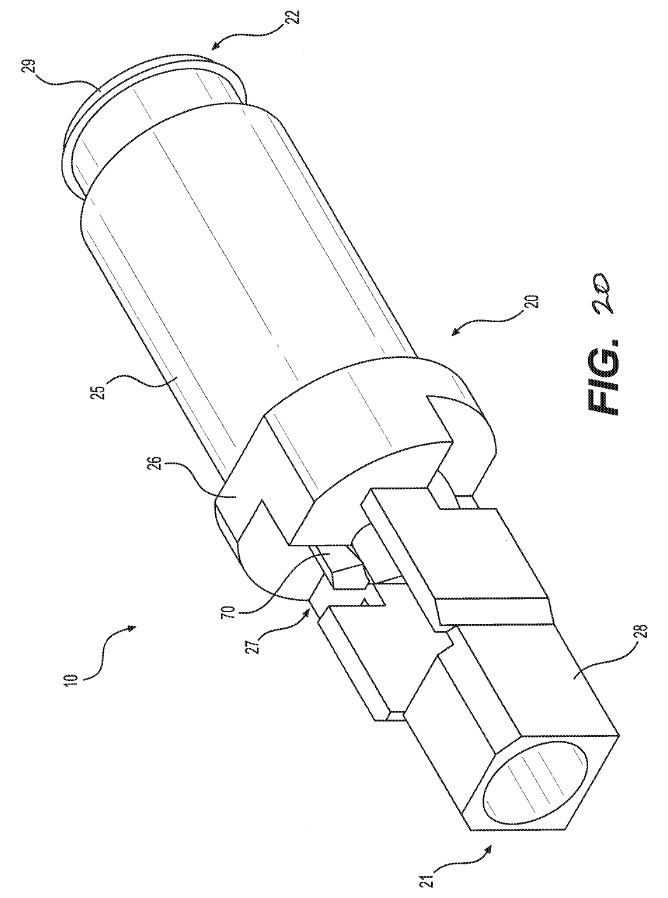

FIGS. 16-21 illustrate an exemplary hardened fiber optical connector 10 in accordance with various aspects of the disclosure. As shown in FIG. 16, the connector 10 includes an inner housing 20, a preterminated fiber optic cable 30, a boot 40, a shroud 80, and a coupling nut 85. The preterminated fiber optic cable 30 may be, for example, a Miniflex^{®} QuikPush^{®} fiber cable, as illustrated and described in U.S. Patent No. 8,439,577, which is incorporated herein by reference.

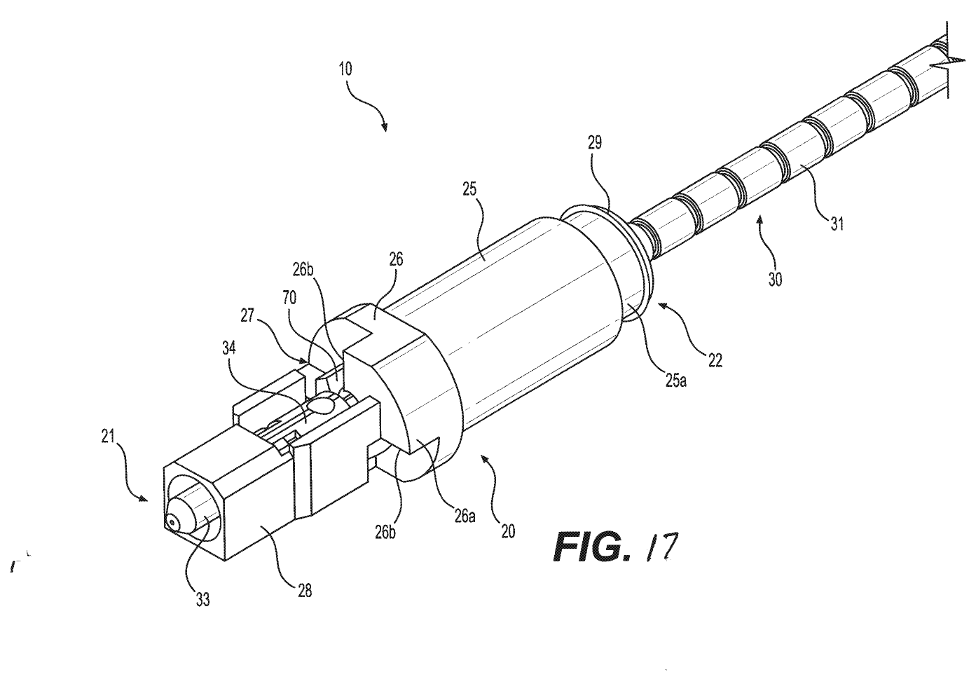

As illustrated in FIG. 17, the inner housing 20 extends from a first end 21 to a second end 22 along a longitudinal axis X and includes a barrel portion 25, a mid-section 26, a latching portion 27, and a connector shell portion 28. The connector shell portion 28 is at the first end 21 of the inner housing 20, the barrel portion 25 is at the second end 22 of the inner housing 20, and the mid-section 26 and latching portion 27 are between the connector shell portion 28 and the barrel portion 25 in the longitudinal direction.

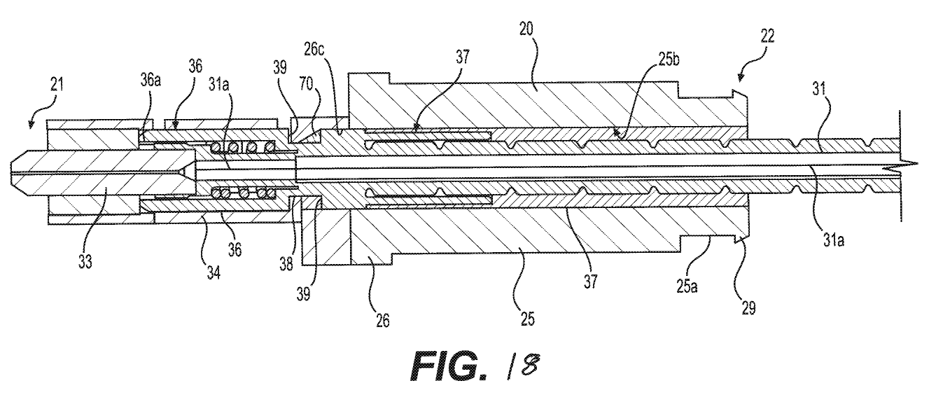

As illustrated in FIG. 18, the barrel portion 25 includes a reduced diameter portion 25a and one or more barbs 29 configured to couple with the boot 40. The barrel portion 25 includes a throughbore 25b extending in the longitudinal direction. The throughbore 25b is configured to receive the preterminated fiber optic cable 30 and allow the preterminated cable 30 to pass therethrough into the connector shell portion 28. As shown in FIGS. 16 and 18, the barb 29 may include a ridge that projects radially outward from the second end 22 of inner housing 20. In some embodiments, one barb 29 may be provided on barrel portion 25. In other embodiments, two or more barbs 29 may be provided on barrel portion 25. It is also contemplated that the barb 29 may include any other well-known method to secure boot 40 with the barrel portion 25. As shown in FIG. 17, boot 40 may be disposed over and around the barb 29. The boot 40 may be a flexible member that allows an interface between connector 10 and optical fiber cable 30 to bend and rotate. For example, the boot 40 may be formed from a flexible material such as KRAYTON.

The preterminated fiber optic cable 30 includes a fiber optic cable 31 preterminated by a fiber connector 32, which includes a ferrule 33, and a ferrule holder 34, as would be understood by persons of ordinary skill in the art. The optical fiber cable 31 holds a single strand of 125μm diameter single mode optical fiber 31a, which may be protected by buffering layers and an outer sheath. The optical fiber 31a is held in a bore of the ferrule 33, as would be understood by persons skilled in the art. The fiber connector 32 may be, for example, a PPC^{®} Balistix (QuikPush^{®}) connector. The ferrule holder 34 includes a neck portion 35 formed by an annular groove 38 between a first end portion 36 and a second end portion 37 of the ferrule holder 34. The ferrule 33 extends from the first end portion 36 of the ferrule holder 34. The inner housing 20 is configured to be coupled with the fiber connector 32, as will be described in more detail below.

As best shown in FIGS. 17, 19, and 20, the mid-section 26 includes a portion 26a having an enlarged dimension in the longitudinal direction and having radially-extending flats 26b. The enlarged portion 26a and the flats 26b are configured to align the inner housing 20 with the shroud 80, as would be understood by persons of ordinary skill in the art. The mid-section 26 includes a throughbore 26b that continues from the throughbore 25b of the barrel portion 25 with a substantially same inside diameter.

The connector shell portion 28 is configured to be received by a mating optical fiber receptacle or socket. The connector shell portion 28 may be configured to be received by a receptacle that is configured to receive a connector having convenient push/pull style mating that allows for push/pull engagement/disengagement between the connector 10 and the mating optical fiber socket. For example, in some aspects, the receptacle may be configured to receive a "Subscriber Connector," or SC connector, as originally developed by NTT^{®}, which is well-known by persons having ordinary skill in the art.

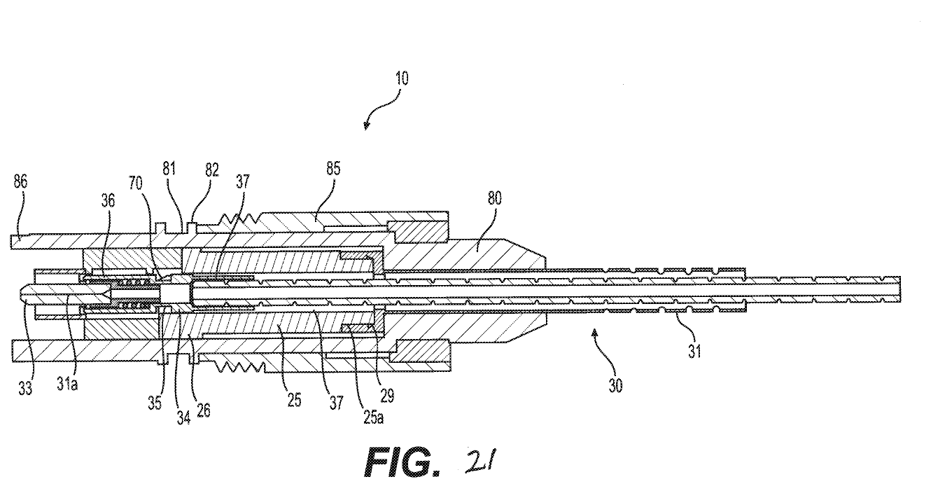

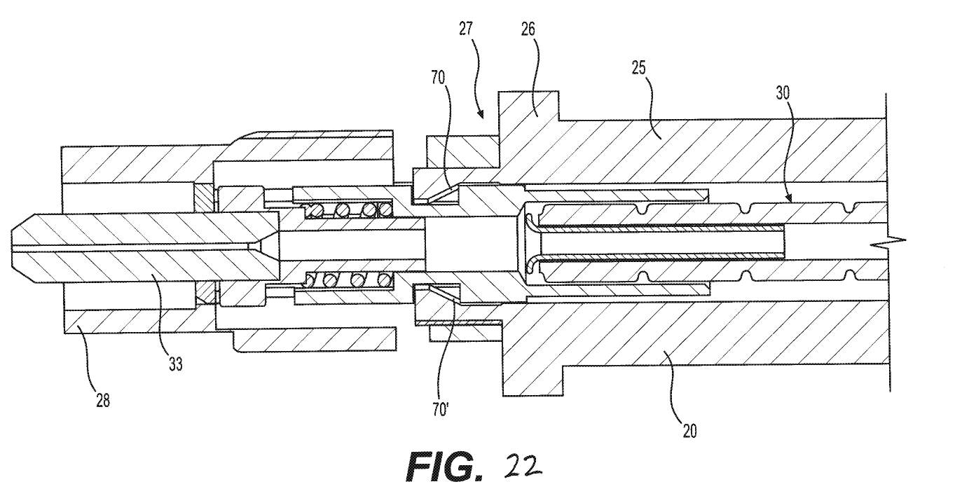

As best illustrated in FIGS. 17-19, the latching portion 27 may be disposed at the mid-section 26 of the inner housing 20. The latching portion 27 includes one or more latches 70 that extend radially inward into the throughbore 26c of the mid-section 26 of the inner housing 20. As shown in FIGS. 18 and 21, the latch 70 is configured to extend into the annular groove forming the neck portion 35 of the ferrule holder 34. Although FIGS. 17-19 illustrate a single latch 70, the latching portion may include two latches 70, 70' equidistantly arranged around a circumference of the mid-section 26, as shown in FIG. 22. Alternatively, the latching portion 27 may include three or more latches. For example, the latching portion 27 may include four latches disposed equidistantly around the circumference of mid-section 26. It is further contemplated that latches may be disposed irregularly around the circumference of mid-section 26.

The latch 70 is configured as a cantilevered member attached at a first end to the mid-section and having a second free end. The latch 70 is configured to move radially outward upon application of an outward force and is configured to return to its position extending into the throughbore 26c of the mid-section 26 upon removal of the outward force. As a result of this configuration, the latch 70 is configured to provide a snap-fit and/or an interference fit with optical fiber connector sub-assembly 32. For example, the latch 70 is configured to be received by the neck portion 35 of the ferrule holder 34 when the preterminated cable 30 is received by the inner housing 20.

The shroud 80 has a first end 83 and a second end 84. The first end 83 of the shroud 80 includes at least one opening (not numbered) defined by shroud 80. The at least one opening extends from a medial portion of the shroud 80 to the first end 83. In the illustrated embodiment, the shroud 80 includes a pair of openings on opposite sides of the first end 83, thereby defining alignment portions or fingers 86. In some aspects, the alignment fingers 86 may have different shapes so that the connector 10 and receptacle (not shown) only mate in one orientation. The medial portion of the shroud 80 may include a groove 81 for seating an O-ring (not shown). The O-ring is configured to provide a weatherproof seal between the connector 10 and the receptacle (not shown) or protective cap (not shown) that is configured to cover a front end of the shroud 80 and the ferrule 33. The medial portion may also include a shoulder 82 that provides a stop for the coupling nut 85. The coupling nut 85 has a passageway sized so that it fits over the second end 84 of the shroud 80 and easily rotates about the medial portion of shroud 80. In other words, the coupling nut 85 cannot move beyond the shoulder 82, but the coupling nut 85 is able to rotate with respect to shroud 80.

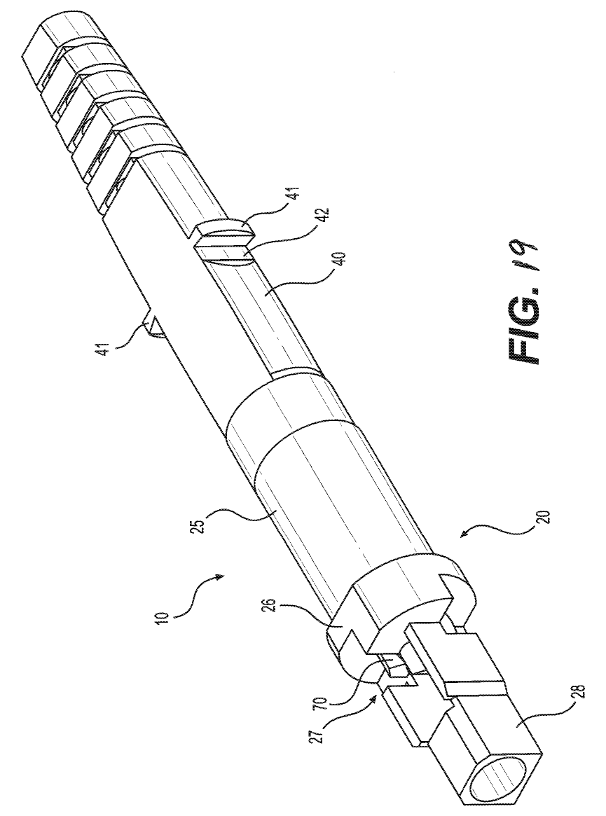

To assemble the connector 10, the coupling nut 85, the shroud 80, and the boot 40 are moved over the preconnectorized cable 30. Viewed differently, the preconnectorized cable 30 is pushed through the coupling nut 85, the shroud 80, and the boot 40 such that coupling nut 85 is furthest from the ferrule 33 and the boot 40 is nearest the ferrule 33. The preconnectorized cable 30 is then pushed into the inner housing 20 until the first end portion 36 of the ferrule holder 34 reaches the latching portion 27. The first end portion 36 of the ferrule holder 34 includes a ramped surface 36a that is configured to urge the latch 70 radially outward as the preconnectorized cable 30 is further pushed toward the first end 21 of the inner housing 20. When the annular groove 38 at the neck portion 35 of the ferrule holder 34 reaches the latch 70, the latch returns to its position extending into the throughbore 26c of the mid-section 26 in the absence of the force from the first end portion 36 of the ferrule holder 34. The radial surfaces 39 that define the groove 38 are not configured to urge the latch 70 radially outward, but instead are configured to prevent movement of the ferrule holder 34 relative to the inner housing 20 in the longitudinal direction. The boot 40 is then pushed over the barb 29 and onto the reduced diameter portion 25a at the second end 22 of the barrel portion 25 of the inner housing 20 to the position shown in FIGS. 18 and 19. Next, the shroud 80 and coupling nut 85 are pushed over the boot 40 and inner housing 20 to reach their positions shown in FIG. 21. In some aspects, the boot 40 may include one or more retention members 41 that extend from an outer surface 42 of the boot and are configured to be compressed onto the outer surface 42 of the boot 40 by the shroud 80 as the shroud is moved over the boot 40 and inner housing 20. The shroud 80 and coupling nut 85 may be pushed together or separately.

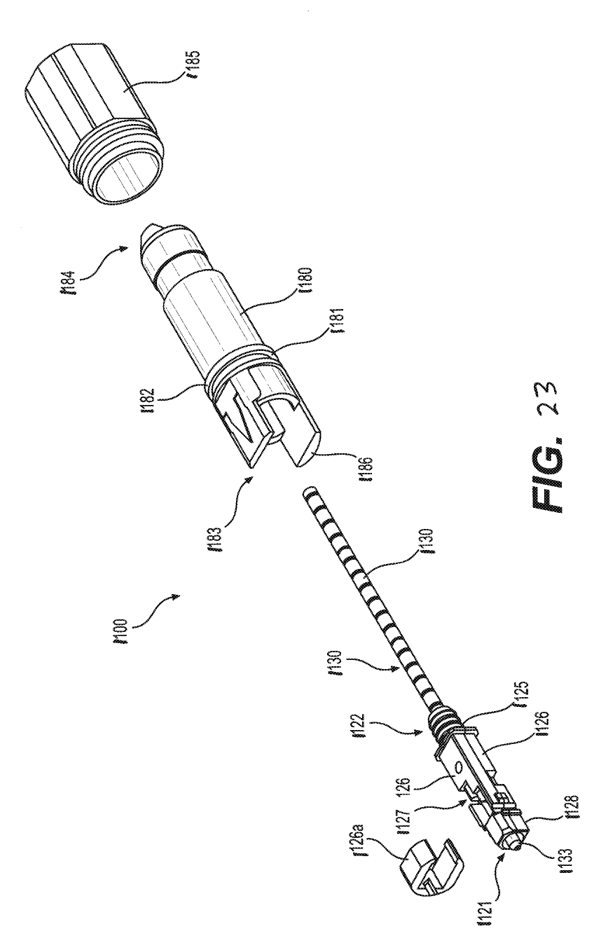

FIGS. 23-25 illustrate another exemplary hardened fiber optical connector 1100 in accordance with various aspects of the disclosure. As shown in FIG. 16, the connector 1100 includes an inner housing 1120, a preterminated fiber optic cable 1130, a shroud 1180, and a coupling nut 1185. The preterminated fiber optic cable 30 may be, for example, a Miniflex^{®} QuikPush^{®} fiber cable, as illustrated and described in U.S. Patent No. 8,439,577, which is incorporated herein by reference.

As illustrated in FIG. 17, the inner housing 1120 extends from a first end 1121 to a second end 1122 along a longitudinal axis X and includes a rear portion 1125, a mid-section 1126, a latching portion 1127, and a connector shell portion 1128. The connector shell portion 1128 is at the first end 1121 of the inner housing 1120, the rear portion 1125 is at the second end 1122 of the inner housing 1120, and the mid-section 1126 and latching portion 1127 are between the connector shell portion 1128 and the rear portion 1125 in the longitudinal direction.

As illustrated in FIG. 18, the rear portion 1125 includes a reduced diameter portion 1125a having one or more barbs 1129 configured to couple with a retention structure 1187 of the shroud 1180. The rear portion 1125 includes a throughbore 1125b extending in the longitudinal direction. The throughbore 1125b is configured to receive the preterminated fiber optic cable 1130 and allow the preterminated cable 1130 to pass therethrough into the connector shell portion 1128.

The preterminated fiber optic cable 1130 includes a fiber optic cable 1131 preterminated by a fiber connector 1132, which includes a ferrule 1133, and a ferrule holder 1134, as would be understood by persons of ordinary skill in the art. The optical fiber cable 1131 holds a single strand of 125μm diameter single mode optical fiber (not shown), which may be protected by buffering layers and an outer sheath. The optical fiber (not shown) is held in a bore of the ferrule 1133, as would be understood by persons skilled in the art. The fiber connector 1132 may be, for example, a PPC^{®} Balistix (QuikPush^{®}) connector. The ferrule holder 1134 includes a neck portion 1135 formed by an annular groove 1138 between a first end portion 1136 and a second end portion 1137 of the ferrule holder 1134. The ferrule 1133 extends from the first end portion 1136 of the ferrule holder 1134. The inner housing 1120 is configured to be coupled with the fiber connector 1132, as will be described in more detail below.

A clip 1126a may be removably coupled with the mid-section 1126. The removable clip 1126a has an enlarged radial dimension relative to the mid-section 1126 and includes transversely-extending flats 1126b. The removable clip 1126a and the flats 1126b are configured to align the inner housing 1120 with the shroud 1180, as would be understood by persons of ordinary skill in the art. The mid-section 1126 includes a throughbore 1126b that continues from the throughbore 1125b of the rear portion 1125 with a substantially same inside diameter.

The connector shell portion 1128 is configured to be received by a mating optical fiber receptacle or socket. The connector shell portion 1128 may be configured to be received by a receptacle that is configured to receive a connector having convenient push/pull style mating that allows for push/pull engagement/disengagement between the connector 1100 and the mating optical fiber socket. For example, in some aspects, the receptacle may be configured to receive a "Subscriber Connector," or SC connector, as originally developed by NTT^{®}, which is well-known by persons having ordinary skill in the art.

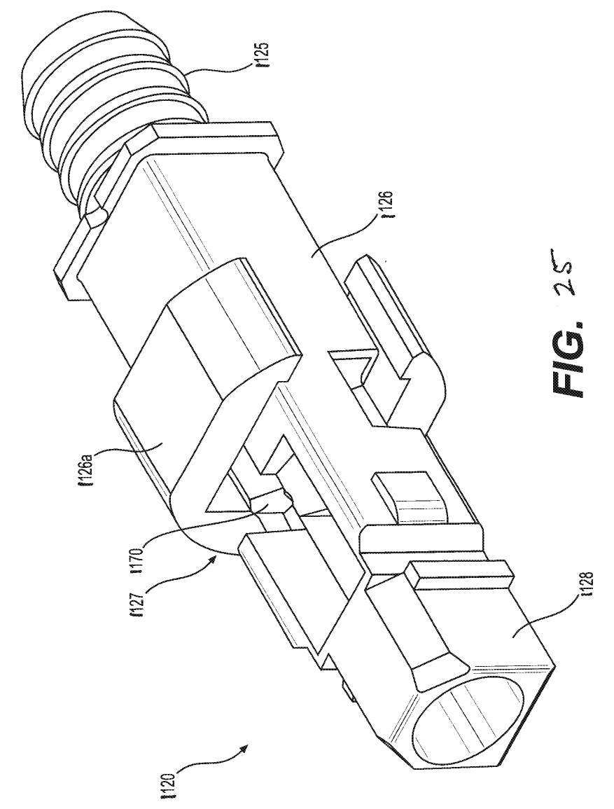

As best illustrated in FIG. 25, the latching portion 1127 may be disposed at the mid-section 1126 of the inner housing 1120. The latching portion 1127 includes one or more latches 1170 that extend radially inward into the throughbore 1126b of the mid-section 1126 of the inner housing 1120. The latch 1170 is configured to extend into the annular groove forming the neck portion 1135 of the ferrule holder 1134. Although FIGS. 23-25 illustrate a single latch 1170, the latching portion 1127 may include two or more latches, as described above.

The latch 1170 is configured as a cantilevered member attached at a first end to the mid-section and having a second free end. The latch 1170 is configured to move radially outward upon application of an outward force and is configured to return to its position extending into the throughbore 1126b of the mid-section 1126 upon removal of the outward force. As a result of this configuration, the latch 1170 is configured to provide a snap-fit and/or an interference fit with optical fiber connector sub-assembly 1132. For example, the latch 1170 is configured to be received by the neck portion 1135 of the ferrule holder 1134 when the preterminated cable 1130 is received by the inner housing 1120.

The shroud 1180 has a first end 1183 and a second end 1184. The first end 1183 of the shroud 1180 includes at least one opening (not numbered) defined by shroud 1180. The at least one opening extends from a medial portion of the shroud 1180 to the first end 1183. In the illustrated embodiment, the shroud 1180 includes a pair of openings on opposite sides of the first end 1183, thereby defining alignment portions or fingers 1186. In some aspects, the alignment fingers 1186 may have different shapes so that the connector 1100 and receptacle (not shown) only mate in one orientation. The medial portion of the shroud 1180 may include a groove 1181 for seating an O-ring (not shown). The O-ring is configured to provide a weatherproof seal between the connector 1100 and the receptacle (not shown) or protective cap (not shown) that is configured to cover a front end of the shroud 1180 and the ferrule 1133. The medial portion may also include a shoulder 1182 that provides a stop for the coupling nut 1185. The coupling nut 1185 has a passageway sized so that it fits over the second end 1184 of the shroud 1180 and easily rotates about the medial portion of shroud 1180. In other words, the coupling nut 1185 cannot move beyond the shoulder 1182, but the coupling nut 1185 is able to rotate with respect to shroud 1180.

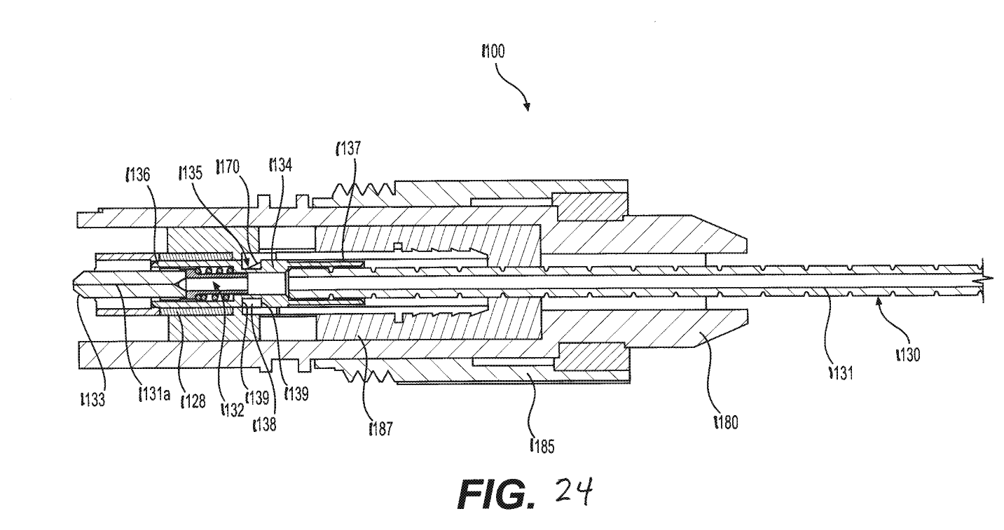

To assemble the connector 1100, the coupling nut 1185 and the shroud 1180 are moved over the preconnectorized cable 1130. Viewed differently, the preconnectorized cable 1130 is pushed through the coupling nut 1185 and the shroud 80 such that the coupling nut 1185 is further from the ferrule 1133. The preconnectorized cable 1130 is then pushed into the inner housing 1120 until the first end portion 1136 of the ferrule holder 1134 reaches the latching portion 1127. The first end portion 1136 of the ferrule holder 1134 includes a ramped surface 1136a that is configured to urge the latch 1170 radially outward as the preconnectorized cable 1130 is further pushed toward the first end 1121 of the inner housing 1120. When the annular groove 1138 at the neck portion 1135 of the ferrule holder 1134 reaches the latch 1170, the latch returns to its position extending into the throughbore 1126b of the mid-section 1126 in the absence of the force from the first end portion 1136 of the ferrule holder 1134. The radial surfaces 1139 that define the groove 1138 are not configured to urge the latch 1170 radially outward, but instead are configured to prevent movement of the ferrule holder 1134 relative to the inner housing 1120 in the longitudinal direction. The shroud is then pushed over the barbs 29 at the second end 22 of the rear portion 25 and over the inner housing 20 to the position shown in FIG. 24. Next, the coupling nut 85 is pushed over the shroud 80 to reach its position shown in FIG. 24. The shroud 80 and coupling nut 85 may be pushed together or separately.

The foregoing description of exemplary embodiments provides illustration and description, but is not intended to be exhaustive or to limit the embodiments described herein to the precise form disclosed. Modifications and variations are possible in light of the above teachings or may be acquired from practice of the embodiments.

Although the invention has been described in detail above, it is expressly understood that it will be apparent to persons skilled in the relevant art that the invention may be modified without departing from the spirit of the invention. Various changes of form, design, or arrangement may be made to the invention without departing from the spirit and scope of the invention. Therefore, the above mentioned description is to be considered exemplary, rather than limiting, and the true scope of the invention is that defined in the following claims.

No element, act, or instruction used in the description of the present application should be construed as critical or essential to the invention unless explicitly described as such. Also, as used herein, the article "a" is intended to include one or more items. Where only one item is intended, the term "one" or similar language is used. Further, the phrase "based on" is intended to mean "based, at least in part, on" unless explicitly stated otherwise.

What is claimed is:

1. A fiber optical connector comprising:
a shroud;
an inner housing disposed within the shroud, the inner housing including a barrel that further includes an inner lumen configured to receive an optical fiber cable, the barrel having a first end and a second end;
one or more latches extending from the first end of the barrel;
a boot having a distal region and a proximate region;
a ferrule housing subassembly that includes a ferrule holder carrier that is configured to receive a ferrule;
a coupler;
wherein the coupler defines a passageway configured to surround the shroud and wherein the coupler is configured to rotate about a medial portion of the shroud;
wherein the latches engage with the ferrule holder carrier in order to secure the barrel with the ferrule housing subassembly;
wherein the distal region of the boot is configured to slide over a reduced diameter portion at the second end of the barrel such that the distal region of the boot and the inner housing are disposed within the shroud; and
wherein the boot, the inner housing, and the shroud are configured to provide a weatherproof connection.

2. The fiber optical connector of claim 1, wherein the latches are biased inward toward a center axis of the barrel.

3. The fiber optical connector of claim 1, wherein the latches provide a snap-fit and/or an interference fit with the ferrule housing sub-assembly.

4. The fiber optical connector of claim 1, wherein the first end of the barrel includes a protruding portion that is configured to anchor an outer housing on the connector.

5. The fiber optical connector of claim 1, wherein the second end of the barrel includes a barb member that projects outward from the second end of the barrel and that is configured for attachment to a boot.

6. A fiber optical connector comprising:
a ferrule housing sub-assembly that includes a ferrule holder carrier that is configured to receive a ferrule,
a barrel having a first end and a second end, the barrel defining a lumen configured to receive the ferrule housing sub-assembly and an optical fiber cable;
a boot having a distal region that is affixed to the second end of the barrel;
a shroud configured to mate with a receptacle;
a coupling member;
wherein the coupling member defines a passageway configured to surround the shroud wherein the coupling member is configured to rotate about a medial portion of the shroud;
wherein the barrel and the distal region of the boot are disposed within the shroud; and
wherein the boot, the inner housing, and the shroud are configured to provide a weatherproof connection.

7. The fiber optical connector of claim 6, wherein the shroud defines a plurality of alignment portions which are configured to mate with a receptacle.

8. The fiber optical connector of claim 7, wherein each alignment portion in the plurality of alignment portions is an elongated member which extends away from the shroud.

9. The fiber optical connector of claim 6, wherein the barrel further comprises a reduced diameter portion at the second end of the barrel wherein the distal region of the boot is configured to slide over the reduced diameter portion.

10. The fiber optical connector of claim 6, where a barb is defined at the second end of the barrel to retain the boot on the reduced diameter portion.

11. The fiber optical connector of claim 6, further comprising an O-ring disposed within an annular groove defined by the shroud wherein the O-ring is configured to seal the shroud against the receptacle.

12. The fiber optical connector of claim 6 wherein the distal region of the boot is disposed between the barrel and the shroud, and an intermediate region of the boot is disposed between a cable and the shroud.

13. The fiber optical connector of claim 6 further comprising a clip configured to align the barrel with the shroud.

14. The fiber optical connector of claim 13, wherein the clip includes a transversely extending flat.

15. The fiber optical connector of claim 6, further comprising a shoulder defined on an outer surface of the shroud wherein the shoulder is configured to abut the coupling member.

16. The fiber optical connector of claim 15, wherein the shoulder defines one side of an annular groove defined by the shroud.

17. A fiber optical connector comprising:
a shroud;
an inner housing disposed within the shroud, the inner housing including a barrel that further includes an inner lumen configured to receive an optical fiber cable, the barrel having a first end and a second end;
one or more latches extending from the first end of the barrel;
a boot having a distal region and a proximate region;
a ferrule housing subassembly;
a coupler;
wherein the coupler defines a passageway configured to surround the shroud and wherein the coupler is configured to rotate about a medial portion of the shroud;
wherein the latches engage with the ferrule housing subassembly;
wherein the distal region of the boot is configured to slide over a reduced diameter portion of the barrel such that the distal region of the boot and the inner housing are disposed within the shroud; and
wherein the boot, the inner housing, and the shroud are configured to provide a weatherproof connection.

18. The fiber optical connector of claim 17, wherein the latches are biased inward toward a center axis of the barrel.

19. The fiber optical connector of claim 17, wherein the latches provide a snap-fit and/or an interference fit with the ferrule housing sub-assembly.

20. The fiber optical connector of claim 17, wherein the first end of the barrel includes a protruding portion that is configured to anchor an outer housing on the connector.

21. The fiber optical connector of claim 17, wherein the second end of the barrel includes a barb member that projects outward from the second end of the barrel and that is configured for attachment to a boot.
